(19) United States
(12) Patent Application Publication
(10) Pub. No.: US 2025/0330350 A1
(43) Pub. Date: Oct. 23, 2025

(54) PULSE WIDTH MODULATION CHANNEL DECODING TECHNIQUES

(71) Applicant: Analog Devices, Inc., Wilmington, MA (US)

(72) Inventor: Kenneth G. Richardson, Erie, CO (US)

(21) Appl. No.: 18/991,267

(22) Filed: Dec. 20, 2024

Related U.S. Application Data
(60) Provisional application No. 63/637,847, filed on Apr. 23, 2024.

(51) Int. Cl. H04L 25/49

(52) U.S. Cl. CPC H04L 25/4902

(57) ABSTRACT

Techniques for decoding a pulse width modulation (PWM) signal transmitted across an isolation barrier, such as within a gate driver, are described. The techniques utilize a PWM modulation scheme that uses four or more levels to encode and decode data, ensuring accurate and efficient communication across the isolation barrier. Using these techniques, the pulse modulator generates a PWM signal with four or more distinct modulation levels, where each level represents different combinations of AC and DC components, allowing the encoding of two bits of data per modulation cycle.

### CLAIM FOR PRIORITY

This application claims priority to U.S. Provisional Patent Application Ser. No. 63/637,847, filed Apr. 23, 2024, which is hereby incorporated by reference herein in its entirety.

### FIELD OF THE DISCLOSURE

This document pertains generally, but not by way of limitation, to digital communication systems and, more particularly, to the process of transmission over channels.

### BACKGROUND

Pulse Width Modulation (PWM) is an important technique in the control of power electronics, particularly when it comes to the operation of gate drivers in inverter circuits. An inverter is an electronic device that converts direct current (DC) into alternating current (AC), and PWM is used to control the output waveform of the inverter.

Gate drivers are the intermediary components that actuate power switches, such as field-effect transistors (FETs) or insulated-gate bipolar transistors (IGBTs), in an inverter circuit. These switches are responsible for creating the AC output from the DC input. PWM signals are used to control the gate drivers, effectively turning the power switches on and off at high frequencies. The duration of the “on” time of each pulse (the duty cycle) determines the output characteristics of the inverter, such as the voltage and frequency of the AC output.

The precision of PWM allows for fine control over the power switches, which is essential for the efficiency and performance of the inverter. By adjusting the duty cycle, the inverter may produce a sine wave-like AC output, which is important for many applications that require a clean and stable AC power source.

In the context of inverters, PWM decoding refers to the inverter's ability to interpret the PWM signal to produce the desired AC output. The inverter's control logic takes the PWM signal and uses it to manage the timing and sequence of the gate driver activation, which in turn controls the power switches.

### SUMMARY OF THE DISCLOSURE

This disclosure is directed to techniques for decoding a pulse width modulation (PWM) signal transmitted across an isolation barrier, such as within a gate driver. The techniques are especially useful in high-noise environments, such as isolated gate drivers, where reliable data transmission and decoding are important. The techniques employ a PWM modulation scheme that uses four or more levels to encode and decode data, ensuring accurate and efficient communication across the isolation barrier. Using these techniques, the pulse modulator generates a PWM signal with four or more distinct modulation levels, where each level represents different combinations of AC and DC components, allowing the encoding of two bits of data per modulation cycle. Advantageously, the techniques of this disclosure allow for asynchronous orthogonal decoding, reducing the risk of unintended bit errors in high-noise environments.

In some aspects, this disclosure is directed to a system for decoding a pulse width modulation (PWM) signal transmitted through a channel, the system comprising: a pulse modulator configured to generate a PWM signal, wherein the PWM signal is selected from four modulation levels; a decoder including an AC detector and a DC detector; a channel configured to transmit the PWM signal from the pulse modulator to the decoder; the AC detector configured to detect an alternating current (AC) component of the PWM signal; and the DC detector configured to detect a direct current (DC) component of the PWM signal.

In some aspects, this disclosure is directed to a method for decoding a pulse width modulation (PWM) signal transmitted across a channel, the method comprising: generating a PWM signal, wherein the PWM signal is selected from four modulation levels; transmitting the PWM signal across the channel; detecting an alternating current (AC) component of the PWM signal; and detecting a direct current (DC) component of the PWM signal.

In some aspects, this disclosure is directed to a system for decoding a pulse width modulation (PWM) signal transmitted through a channel, the system comprising: a pulse modulator configured to generate a PWM signal having four modulation levels; a decoder including an AC detector and a DC detector; a channel configured to transmit the PWM signal from the pulse modulator to the decoder; means for detecting an alternating current (AC) component of the PWM signal; and means for detecting a direct current (DC) component of the PWM signal.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 is a simplified schematic diagram of an example of a current control system that may implement various techniques of this disclosure.

FIG. 2 is a block diagram of an example of a fault controller of the isolated gate driver circuit of FIG. 1.

FIG. 3 is a block diagram depicting an example of a system for transmitting data.

FIG. 4 is a block diagram of an example of a system for decoding a pulse width modulation (PWM) signal transmitted through a channel using various techniques of this disclosure.

FIG. 5 depicts six waveforms from a simulation of the system of FIG. 4.

FIG. 6 is a flow diagram of an example of a method for decoding a pulse width modulation signal transmitted across a channel using various techniques of this disclosure.

### DETAILED DESCRIPTION

In the field of power electronics, the precise control of switching transistors, such as Insulated Gate Bipolar Transistors (IGBTs) and Field-Effect Transistors (FETs), is important for efficient operation. Traditional gate driving techniques often face challenges in maintaining signal integrity, especially when signals traverse isolation barriers. These barriers are used for safety and operational integrity but introduce complexities in signal transmission, particularly when dealing with high-speed data or fault data transmission across the high voltage and low voltage sides of a system. The present inventor has recognized that traditional techniques for transmitting and decoding data across an isolation barrier in high-noise environments, such as those found in isolated gate drivers, struggle with maintaining data integrity and synchronization in the presence of significant noise, leading to potential bit errors and inefficient use of physical channels.

This disclosure is directed to techniques for decoding a pulse width modulation (PWM) signal transmitted across an isolation barrier, such as within a gate driver. The techniques are especially useful in high-noise environments, such as isolated gate drivers, where reliable data transmission and decoding are important. The techniques employ a PWM modulation scheme that uses four or more levels to encode and decode data, ensuring accurate and efficient communication across the isolation barrier. Using these techniques, the pulse modulator generates a PWM signal with four or more distinct modulation levels, where each level represents different combinations of AC and DC components, allowing the encoding of two bits of data per modulation cycle. Advantageously, the techniques of this disclosure allow for asynchronous orthogonal decoding, reducing the risk of unintended bit errors in high-noise environments.

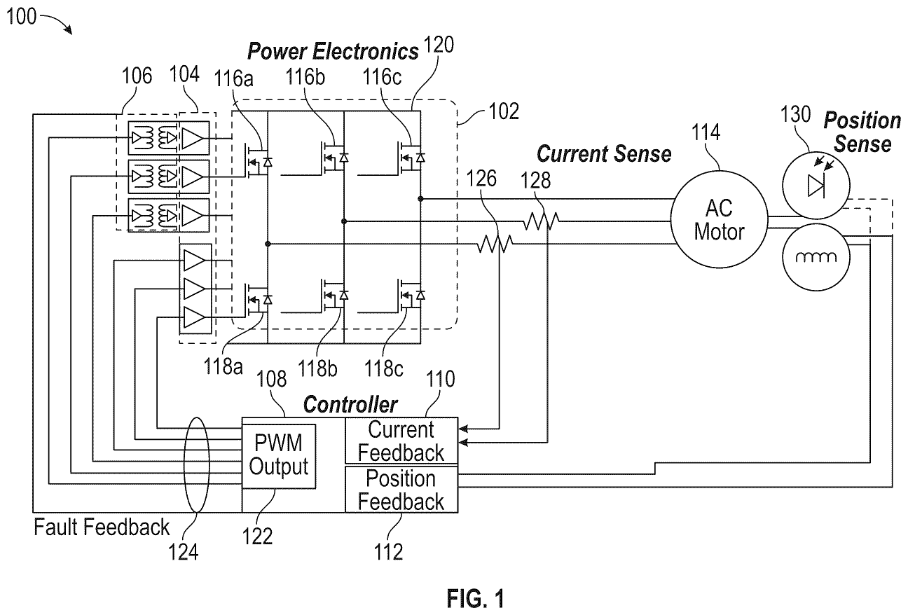

FIG. 1 is a simplified schematic diagram of an example of a current control system 100 that may implement various techniques of this disclosure. In the non-limiting example shown, the current control system 100 forms part of a motor drive signal chain, specifically designed for an alternating current (AC) motor. The current control system 100 includes a three-phase half-bridge circuit 102, gate driver circuits 104, isolator components 106, a controller 108 with a current feedback circuit 110 and a position feedback circuit 112, and sensors, all of which contribute to the precise and efficient operation of the AC motor 114.

The three-phase half-bridge circuit 102 includes six transistors, namely the transistors 116a-116c and the transistors 118a-118c, arranged into three half-bridge configurations. Each half-bridge, e.g., the transistor 116a and the transistor 118a, is responsible for driving one phase of the AC motor 114. The controller 108 controls the transistors within these bridges to switch on and off in a synchronized manner, facilitating the precise control of electrical current flowing through the windings of the AC motor 114. This control is pivotal in managing the speed and torque of the AC motor 114.

Integral to the operation of the three-phase half-bridge circuit 102 are the gate driver circuits 104, which are coupled with the control terminals, e.g., gate terminals, of the transistors, such as Insulated Gate Bipolar Transistors (IGBTs) and Field-Effect Transistors (FETs). The gate driver circuits 104 provide the necessary drive voltage to actuate the transistors, ensuring efficient switching.

For the top half of the three-phase half-bridge circuit 102, which includes the transistors 116a-116c, isolator components 106 are coupled with a gate driver circuit 104. The transistors 116a-116c are coupled with a high voltage supply 120, such as coupled with a battery stack in an electric vehicle. In some examples, the high voltage supply 120 may be 400 volts or higher. The isolator components 106 electrically isolate the low-voltage control side of the gate drivers, such as the side coupled with the controller 108, from the high-voltage power side of the three-phase half-bridge circuit 102. Such isolation protects the controller 108 from high-voltage transients and facilitates safe signal transmission between the controller 108 and the gate driver circuit 104.

The controller 108 is part of a gate driver system configured to control the operation of power electronics based on transmitted data. The controller 108 includes a Pulse Width Modulation (PWM) output circuit 122. The PWM output circuit 122 generates PWM output signals 124 directed to the gate driver circuit 104. The PWM output signals 124 modulate the duty cycle of the transistor switching, thereby controlling the power delivered to the windings of the AC motor 114. Additionally, the controller 108 is equipped with a current feedback circuit 110 and a position feedback circuit 112, which allow closed-loop control.

The current feedback circuit 110 is designed to receive input from a current sensor, such as formed by a current sense resistor 126 and a current sense resistor 128, which are positioned in two phases of the three-phase half-bridge circuit 102. The current feedback circuit 110, via the current sensor, monitor the current flowing through the windings of the AC motor 114, provides real-time feedback to the controller 108. Using this information, the controller 108 may adjust the PWM output signals 124 to ensure the AC motor 114 operates within desired parameters.

The current control system 100 also includes a position sensor 130, such as an optical sensor or a rotary encoder, coupled with the AC motor 114. The position sensor 130 provides precise feedback on the rotor position to the position feedback circuit 112 within the controller 108. Accurate position feedback is important for controlling the speed and position of the AC motor 114 with precision, enabling applications that demand exact motion control.

The current control system 100 is designed to couple each phase of the three-phase half-bridge circuit 102 with a winding in the AC motor 114, facilitating the conversion of electrical energy into mechanical motion. The inclusion of a current sensor and a position sensor provide the necessary feedback for the controller 108 to fine-tune the operation of the AC motor 114 in real-time, thereby optimizing performance and efficiency.

In a motor drive system, such as those implemented in electric vehicle traction drives, an alternating current motor, e.g., AC motor 114, is driven by a three-phase half-bridge circuit controlled by a system controller, e.g., the controller 108. The system controller enables each transistor of the three-phase half-bridge circuit with pulse width modulated patterns, such as generated by PWM output circuit 122. The delivered current from the three-phase half-bridge circuit into the inductance of the motor windings of the AC motor appears as a three-phase sine wave. A function of traction drive system controllers is to operate the motor safely and protect the system and maintain control on the vehicle in system shorts or vehicle accidents.

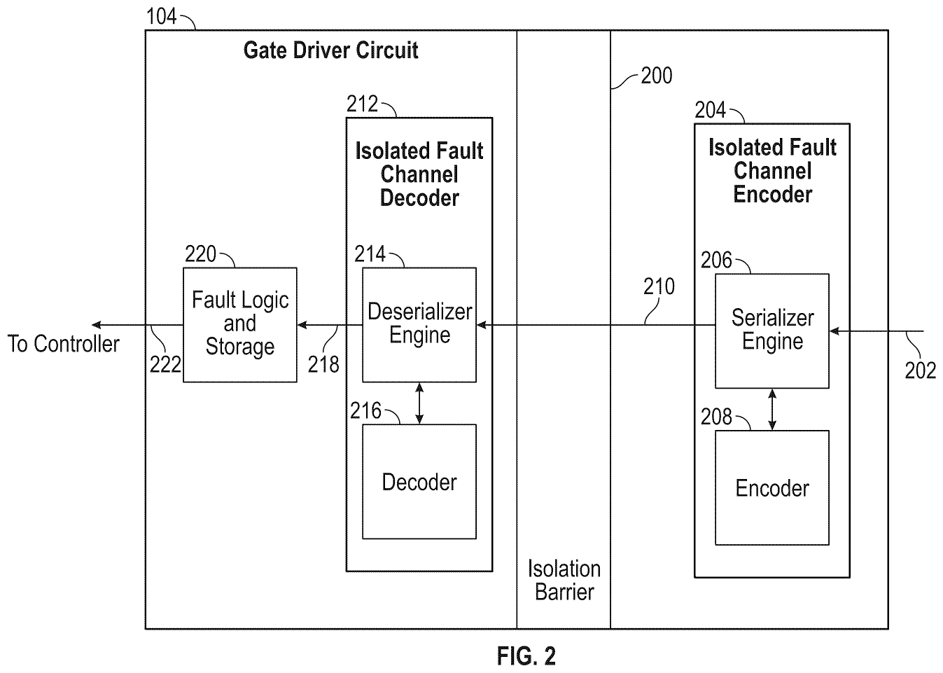

As described in more detail below, the PWM modulation techniques of this disclosure are utilized within the circuitry and components that transmit and receive data across the physical components and structures that make up the isolation barrier, shown as isolation barrier 200 in FIG. 2.

FIG. 2 is a block diagram of an example of a fault controller of the isolated gate driver circuit of FIG. 1. The gate driver circuit 104 includes an isolation barrier 200 to electrically isolate the control circuits (low-voltage side) from the power circuits (high-voltage side), such as those coupled with the high voltage supply 120 of FIG. 1. This isolation is important for safety, preventing high voltages from reaching the control side and protecting users and sensitive electronic components from electric shock or damage. However, the isolation barrier 200 introduces complexities in signal transmission.

Data 202 is received by the controller 108 and, in particular, by the Isolated Fault Channel Encoder 204. The Isolated Fault Channel Encoder 204 includes a serializer engine 206 and an encoder 208. The serializer engine 206 converts the data 202 from a parallel data stream to a serial data stream. The encoder 208 applies a coding scheme to the serial data stream and the serializer engine 206 then transmits the encoded data 210 across the isolation barrier 200. The Isolated Fault Channel Decoder 212 and, in particular, the deserializer engine 214 receives the encoded data 210. The deserializer engine 214 converts the encoded data 210 from a serial data stream to a parallel data stream. A decoder 216 decodes the encoded data 210 and transmits the decoded data 218. In some examples, the decoded data 218 is fault data of an isolated gate driver system, and the fault data may be transmitted to a fault logic and storage 220 to process and store the decoded data 218 and generate an output signal 222. Depending on which fault was reported, the fault logic block may assert a general FAULT output signal to the external controller 108 or choose to disable the primary input path and turn off the gate 104 as part of a safety response mechanism.

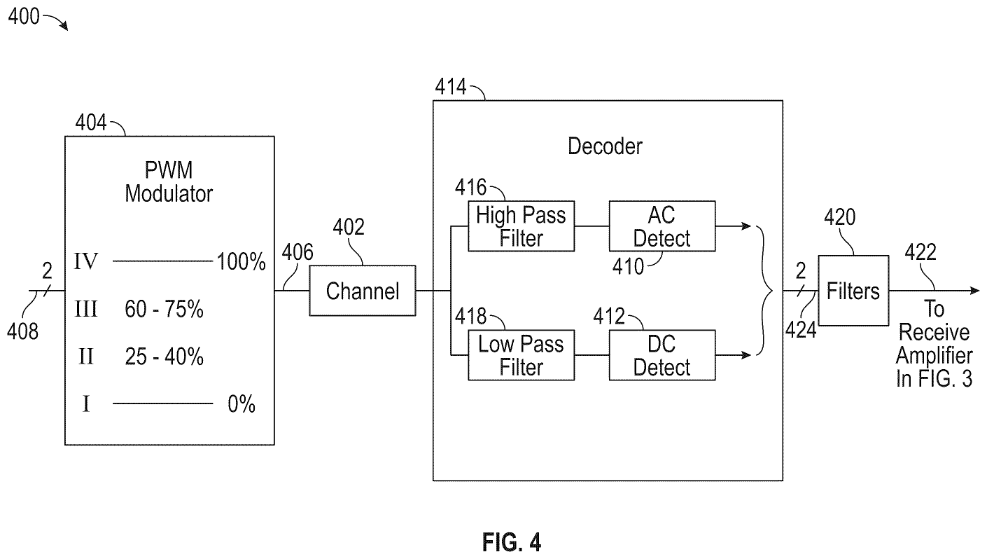

As described in more detail below with respect to FIG. 4, the PWM modulation techniques of this disclosure are utilized within the isolation barrier 200.

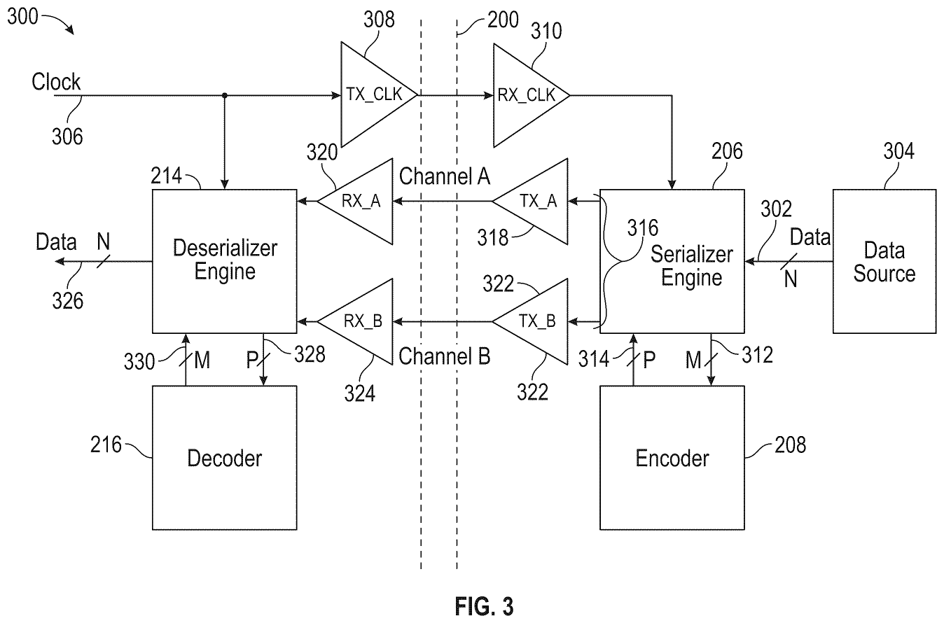

FIG. 3 is a block diagram depicting an example of a system for transmitting data. The system 300 forms part of the controller of FIG. 2. The system 300 includes the serializer engine 206, the encoder 208, the deserializer engine 214, and the decoder 216 of FIG. 2.

The serializer engine 206 is configured for receiving N bits of input data 302 from a data source 304 and grouping the input data 302 into M-bit slices of data, e.g., 3-bit slices of data. Slices of data are ordered segments of the data stream that are the same width as the M-bit encoder input of encoder 208. The N bits of input data may include fault data of an isolated gate driver system, such as faults detected in transistors within the three-phase half-bridge circuit 102 of FIG. 1. The serializer engine 206 groups the data into M-bit slices in preparation for encoding.

The serializer engine 206 is configured for receiving a clock signal 306 to coordinate timing. The clock signal 306 may be amplified by a first clock amplifier 308, e.g., a transmit amplifier, before crossing the isolation barrier 200, and then amplified again by a second clock amplifier 310, e.g., a receive amplifier.

The encoder 208, e.g., an M to P encoder, is coupled with the serializer engine 206 and configured for receiving the M-bit slices of data 312 and transforming each slice of data into P encoded bits 314, e.g., 4 encoded bits. This transformation is designed to take advantage of an R channel communication medium, enhancing the distinction between control bits and data bits, thereby improving the robustness of the system.

The system 300 includes R channels 316, e.g., 2 channels, connected to the serializer engine 206 for transmitting the P encoded bits across the isolation barrier 200, where the P encoded bits are divided between the R channels. The P encoded bits are divided between the R channels, ensuring that the data is transmitted sequentially and efficiently. For simplicity, only 2 channels are depicted in FIG. 3, namely channel A and channel B. Each channel may include two amplifiers: a transmit amplifier and a receive amplifier. Data in channel A may be amplified by a transmit amplifier 318 before crossing the isolation barrier 200 and then amplified again by a receive amplifier 320 after crossing the isolation barrier 200. Similarly, data in channel B may be amplified by a transmit amplifier 322 before crossing the isolation barrier 200 and then amplified again by a receive amplifier 324 after crossing the isolation barrier 200.

The deserializer engine 214 is coupled with the R channels 316 and configured for receiving the transmitted P encoded bits. For example, the deserializer engine 214 is coupled with the receive amplifier 320 of channel A and the receive amplifier 324 of channel B.

The decoder 216 is coupled with the deserializer engine 214 and configured for decoding the P encoded bits 328 back into M-bit slices of data 330. Then, the deserializer engine 214 is configured for reassembling the M-bit slices of data 330 into N bits of output data 326 representing the N bits of input data 302. This reassembly process ensures that the data, once transmitted across the isolation barrier 200, is accurately reconstructed, maintaining the integrity of the data, e.g., fault data, for further processing or action by the system controller, e.g., controller 108 of FIG. 1.

As described in more detail below with respect to FIG. 4, the PWM modulation techniques of this disclosure are utilized within the isolation barrier 200.

FIG. 4 is a block diagram of an example of a system for decoding a pulse width modulation (PWM) signal transmitted through a channel using various techniques of this disclosure. Conceptually speaking, the block diagram of FIG. 4 resides within the isolation barrier 200 of FIG. 3. The system 400 provides isolation, such as galvanic isolation, through a 1-bit channel 402 that is configured to transmit a PWM signal across the channel. In some non-limiting examples, the channel 402 is part of a gate driver, such as Channel A and/or Channel B of the system 300 of FIG. 3. However, the techniques of this disclosure are not limited to use with gate drivers.

In some examples, the channel 402 represents one of the four physical channels in a gate driver. Each physical channel is broken into two logical channels and, using the techniques of this disclosure, the logical channels are distinguished using pulse width modulation. The system 400 encodes two asynchronous logical channels for transmission across a single channel 402, such as a roughly 750 Mbs, on-off keyed 3 GHz near field RF link OOK ISO coupler.

The system 400 includes a pulse modulator 404, e.g., an encoder, configured to generate a PWM signal 406 having four or more modulation levels. It should be noted that the pulse modulator 404 is different than the PWM output circuit 122 of FIG. 1. In FIG. 4, four non-limiting examples of modulation levels are shown and labeled I-IV. The four modulation levels (or states) represent 4 bits. Level I (0% duty cycle) and level IV (100% duty cycle) represent the DC levels. Level II (25-40% modulation) and level III (60-75% modulation) represent intermediate duty cycles, e.g., the AC levels. Level II represents a first intermediate duty cycle greater than 0% and less than 100% and Level III represents a second intermediate duty cycle greater than the first intermediate duty cycle and less than 100%. In systems with more than four levels, there may be additional AC levels beyond levels II and III. In some examples, the pulse width modulation uses different modulation frequencies, which allows additional information to be encoded in the AC signal stream. In other examples, the percentage of modulation in levels II and III may be different than the percentages depicted and described in this disclosure.

The pulse modulator 404 is configured to receive an input signal 408, e.g., a 2-bit signal. Continuing the non-limiting example above, the 2-bit input signal 408 is applied to the transmit amplifier 318 (TX_A) of FIG. 3, e.g., AC channel or DC channel, and applied to the pulse modulator 404. Similarly, the 2-bit input signal 408 is applied to the transmit amplifier 322 (TX_B) of FIG. 3, e.g., DC channel or AC channel, and applied to the pulse modulator 404. In an example of a 2-bit signal, the first bit represents the AC component, e.g., the high-frequency component, and the second bit represents a duty cycle of the PWM signal, e.g., the low-frequency component. The high-frequency component represents whether there is a PWM that is not 0 or 100%. The low-frequency component looks at what the duty cycle is.

The PWM signal 406 is transmitted across the channel 402, e.g., 1-bit channel, and applied to a decoder 414 that includes an AC detector 410 and a DC detector 412. The AC detector 410 is configured to detect an alternating current (AC) component of the PWM signal 406. In some examples, the decoder 414 includes a high pass filter 416 configured to filter the transmitted PWM signal to separate the AC component from the DC component of the PWM signal 406. An example of a high pass filter 416 is a capacitor.

The DC detector 412 is configured to detect a direct current (DC) component of the PWM signal 406. In some examples, the system 400 includes a low pass filter 418 configured to filter the transmitted PWM signal to separate the DC component from the AC component of the PWM signal 406. An example of a low pass filter 418 is an RC filter.

The AC detector 410, e.g., a first sub-channel, is configured to determine whether the PWM signal 406 includes a duty cycle other than 0% or 100%, e.g., whether the PWM signal 406 is modulated (AC on) or not (AC off). In some examples, the AC detector 410 includes a frequency-to-current generator. In other examples, the AC detector 410 includes a full wave rectifier. In these examples, the AC detector 410 includes a comparator, and a current from the frequency-to-current detector or voltage from the full wave rectifier may be applied to the comparator and compared to a reference current or voltage, e.g., threshold. The AC detector 410 outputs a signal representing a O if the duty cycle is either 0% or 100%. The AC detector 410 outputs a signal representing a 1 if the duty cycle is something other than 0% or 100%, e.g., greater than 0% and less than 100%. This signal, e.g., binary signal, is then sent to the decoder 414 for further processing. Using these techniques, the system 400 reconstructs the transmitted bits encoded with a PWM signal using the AC and DC components and outputs the reconstructed signal 424.

In some examples, the AC detector 410 includes a multi-frequency detector configured to detect a frequency of the PWM signal. For example, the pulse modulator 404 may operate at varying frequencies. The multi-frequency detector may be configured to detect which frequency at which the pulse modulator 404 is operating.

Simultaneously, the DC component of the PWM signal 406, such as separated by the low pass filter 418, is fed into the DC detector 412. The DC detector 412, e.g., a second sub-channel, is configured to distinguish between two or more PWM duty cycles based on a threshold duty cycle (or the equivalent), such as a 50% duty cycle. For example, in the example described above, the DC detector 412 is responsible for distinguishing between the upper (100%) and lower (0%) PWM duty cycles based on a threshold duty cycle, e.g., 50%. It compares the amplitude of the DC component against this threshold to determine whether the signal is at a high or low duty cycle. The DC detector 412 is configured to output a signal representing a 0 if an input signal to the DC detector is less than 50% and output a signal representing a 1 if the input signal to the DC detector is greater than 50%. In some examples, the DC detector 412 is configured to distinguish between more than two PWM duty cycles based on multiple threshold duty cycles.

In some examples, the DC detector 412 includes a comparator, such as to provide a 1-bit output. In other examples, the DC detector 412 includes a plurality of comparators or an analog-to-digital converter. The additional comparators or the analog-to-digital converter may output two or more bits to provide finer resolution.

If more than a single AC frequency or more than a single comparison is made in the DC channel, a decoder 414 receives the signals from both the AC detector 410 and the DC detector 412. Its primary function is to separate and/or reconstruct the original multi-bit (more than 2-bit) data that was encoded into the PWM signal. In the case where a single PWM frequency is used in the AC path and only one comparison is made in the DC Path, the data is interpreted as follows:
1.00: 0% Modulation (AC Off, Low DC)
2. 01: 33% Modulation (AC On, Low DC)
3. 10: 67% Modulation (AC On, High DC)
4. 11: 100% Modulation (AC Off, High DC)

In this manner, the system 400 accurately reconstructs the encoded data transmitted across the channel. This process ensures that the original information encoded into the PWM signal is retrieved, maintaining data integrity and reliability even in high-noise environments.

Most sub-channel modulation schemes rely on a synchronous clock to decode. In a synchronous system, however, it may be difficult to maintain excellent local oscillator (LO) locking to the data stream. As such, the system 400 is asynchronous and does not rely on PWM clock synchronization for DC correctness. The system 400 includes an AC path and a DC path, which allows the system 400 to asynchronously and orthogonally decode two bits from a four-level PWM signal 406, such as in a high-noise environment, such as isolated gate drivers in silicon carbide traction inverters. Asynchronous detection may reduce the risk of bit errors. To improve the noise immunity of the overall system, one or more filters 420 may be added at the output of the AC detector 410 and/or the DC detector 412. The output 422 of the system 400 is applied to a receive amplifier, such as the receive amplifier 320 in FIG. 3.

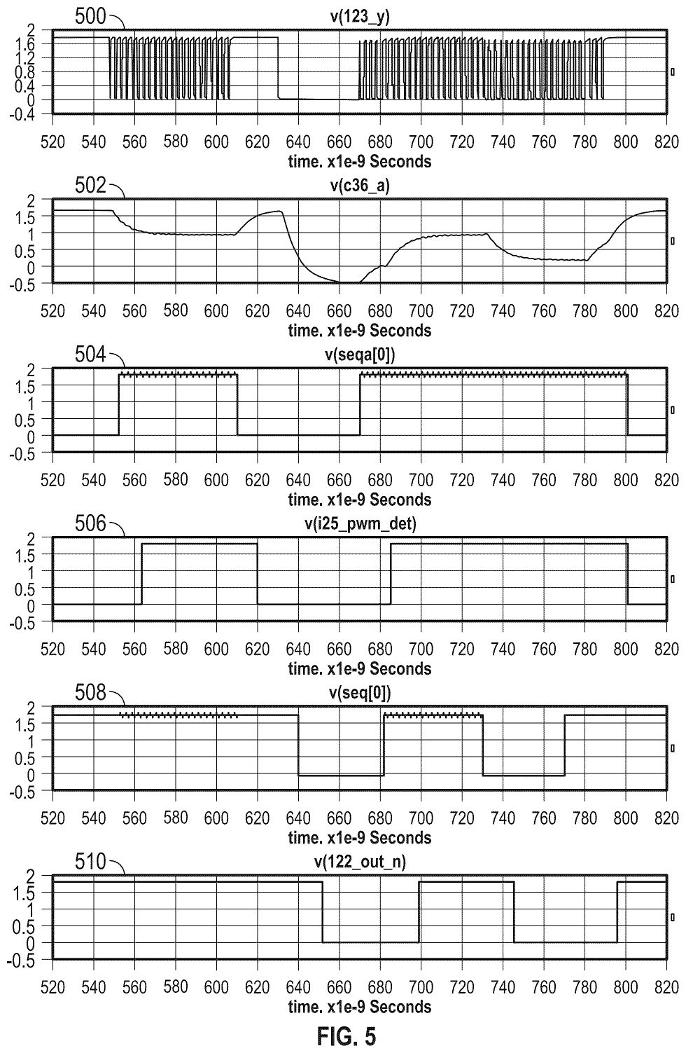

FIG. 5 depicts six waveforms from a simulation of the system 400 of FIG. 4. The x-axis represents time in nanoseconds and the y-axis represents voltage. These waveforms represent various stages of the signal processing, from the generation of the PWM signal to the final decoded outputs. The waveform 500 represents the output of the pulse modulator 404, the waveform 502 represents the output of the low pass filter 418, the waveform 504 represents the input bit that activates the AC path (FIG. level II or level III), the waveform 506 represents the output of the AC detector 410, the waveform 508 represents the input of the DC path (FIG. 4 Level I/II, DC low or Level III/IV, DC high), and the waveform 510 represents the output of the DC detector 412.

The waveform 500 shows the PWM signal generated by the pulse modulator 404 of FIG. 4, which varies according to the encoded data, with each modulation level corresponding to a specific combination of AC and DC components. This waveform is the input signal that is transmitted through the channel across the isolation barrier. When the waveform 504 is high, which represents the AC channel input, there is pulse width modulation. Because of the filtering of the high pass filter 416, there is a delay in the waveform 506, which is the AC channel output, relative to the waveform 504, which is the AC channel input.

The waveform 510 goes low when the average value of the channel signal goes below 50% average amplitude. Because of the filtering of the low pass filter 418, there is a delay in the waveform 510, which is the DC channel output, relative to the waveform 508, which is the DC channel input.

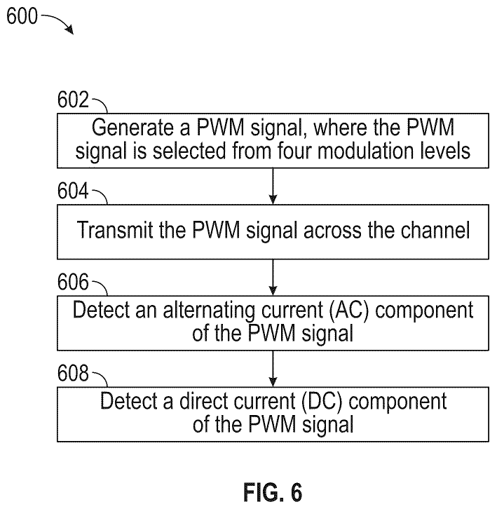

FIG. 6 is a flow diagram of an example of a method for decoding a pulse width modulation signal transmitted across a channel using various techniques of this disclosure. At block 602, the method 600 includes generating a PWM signal, the PWM signal being selected from four distinct modulation levels. For example, the pulse modulator 404 generates the PWM signal 406 that may have levels I-IV in FIG. 4.

At block 604, the method 600 transmits the PWM signal across the channel. For example, the pulse modulator 404 transmits the PWM signal 406 across the channel 402 in FIG. 4 and to the decoder 414.

At block 606, the method 600 detects an alternating current (AC) component of the PWM signal. For example, the AC detector 410 of the decoder 414 of FIG. 4 detects an AC component of the PWM signal 406.

At block 608, the method 600 detects a direct current (DC) component of the PWM signal. For example, the DC detector 412 of the decoder 414 of FIG. 4 detects a DC component of the PWM signal 406.

In this manner, the method 600 reconstructs the transmitted bits encoded with a PWM signal using the AC and DC components and outputs the reconstructed signal.

### Various Notes

Each of the non-limiting claims or examples described herein may stand on its own, or may be combined in various permutations or combinations with one or more of the other examples.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more claims thereof), either with respect to a particular example (or one or more claims thereof), or with respect to other examples (or one or more claims thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact discs and digital video discs), magnetic cassettes, memory cards or sticks, random access memories (RAMs), read only memories (ROMs), and the like.

The above description is intended to be illustrative, and not restrictive. For example, the above-described examples (or one or more claims thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

What is claimed is:

1. A system for decoding a pulse width modulation (PWM) signal transmitted through a channel, the system comprising:
a pulse modulator configured to generate a PWM signal, wherein the PWM signal is selected from four modulation levels;
a decoder including an AC detector and a DC detector;
a channel configured to transmit the PWM signal from the pulse modulator to the decoder;
the AC detector configured to detect an alternating current (AC) component of the PWM signal; and
the DC detector configured to detect a direct current (DC) component of the PWM signal.

2. The system of claim 1, further comprising:
a high pass filter configured to filter the transmitted PWM signal to separate the AC component from the DC component of the PWM signal; and
a low pass filter configured to filter the transmitted PWM signal to separate the DC component from the AC component of the PWM signal.

3. The system of claim 1, wherein the AC detector is configured to determine whether the PWM signal includes a duty cycle other than 0% or 100%.

4. The system of claim 3, wherein the AC detector is configured to:
output a signal representing a 0 if the duty cycle is either 0% or 100%; and
output a signal representing a 1 if the duty cycle is something other than 0% or 100%.

5. The system of claim 1, wherein the DC detector is configured to distinguish between at least two PWM duty cycles based on a threshold duty cycle.

6. The system of claim 5, wherein the threshold duty cycle is 50%, the DC detector being configured to:
output a signal representing a 0 if an input signal to the DC detector is less than 50%; and
output a signal representing a 1 if the input signal to the DC detector is greater than 50%.

7. The system of claim 1, wherein the DC detector is configured to distinguish between more than two PWM duty cycles based on multiple threshold duty cycles.

8. The system of claim 1, wherein the four modulation levels include:
a first level representing 0% duty cycle;
a second level representing 100% duty cycle;
a third level representing a first intermediate duty cycle greater than 0% and less than 100%; and
a fourth level representing a second intermediate duty cycle greater than the first intermediate duty cycle and less than 100%.

9. The system of claim 1, wherein the PWM signal includes a first bit and a second bit, wherein the first bit represents the AC component and the second bit represents a duty cycle of the PWM signal.

10. The system of claim 1, further comprising:
a frequency detector configured to detect a frequency of the PWM signal.

11. A method for decoding a pulse width modulation (PWM) signal transmitted across a channel, the method comprising:
generating a PWM signal, wherein the PWM signal is selected from four modulation levels;
transmitting the PWM signal across the channel;
detecting an alternating current (AC) component of the PWM signal; and
detecting a direct current (DC) component of the PWM signal.

12. The method of claim 11, comprising:
filtering the transmitted PWM signal to separate the AC component of the PWM signal; and
filtering the transmitted PWM signal to separate a DC component of the PWM signal;

13. The method of claim 11, comprising:
determining whether the PWM signal is modulated based on a threshold.

14. The method of claim 13, wherein the threshold is 50%, the method comprising:
outputting a signal representing a 0 if an input signal is less than 50%; and
outputting a signal representing a 1 if the input signal is greater than 50%.

15. The method of claim 11, comprising:
distinguishing between two PWM duty cycles based on a threshold.

16. The method of claim 15, wherein the threshold is 50%, the method comprising:
outputting a signal representing a 0 if an input signal is less than 50%; and
outputting a signal representing a 1 if the input signal is greater than 50%.

17. The method of claim 11, comprising:
distinguishing between more than two PWM duty cycles based on multiple thresholds.

18. The method of claim 11, comprising:
detecting a frequency of the PWM signal.

19. A system for decoding a pulse width modulation (PWM) signal transmitted through a channel, the system comprising:
a pulse modulator configured to generate a PWM signal having four modulation levels;
a decoder including an AC detector and a DC detector;
a channel configured to transmit the PWM signal from the pulse modulator to the decoder;
means for detecting an alternating current (AC) component of the PWM signal; and
means for detecting a direct current (DC) component of the PWM signal.

20. The system of claim 19, wherein the means for detecting the alternating current (AC) component is configured to determine whether the PWM signal includes a duty cycle other than 0% or 100%.
